(19) United States
(12) Patent Application Publication
(10) Pub. No.: US 2012/0214004 A1
(43) Pub. Date: Aug. 23, 2012

(54) METHOD OF MANUFACTURING A GLASS SUBSTRATE FOR USE AS A COVER GLASS FOR A MOBILE ELECTRONIC DEVICE, GLASS SUBSTRATE FOR USE AS A COVER GLASS FOR A MOBILE ELECTRONIC DEVICE, AND MOBILE ELECTRONIC DEVICE

(75) Inventors: Kazuaki HASHIMOTO, Tokyo (JP); Tetsuo TAKANO, Tokyo (JP)

(73) Assignee: HOYA CORPORATION, Tokyo (JP)

(21) Appl. No.: 13/398,452

(22) Filed: Feb. 16, 2012

(30) Foreign Application Priority Data
Feb. 17, 2011 (JP) 2011-032179

(51) Int. Cl. C03C 21/00; B32B 17/06

(52) U.S. Cl. 428/428; 65/30.14

(57) ABSTRACT

A glass substrate manufacturing method of this invention includes a first chemical strengthening process for chemically strengthening a plate-like glass member by ion exchange, a cutting process for cutting the plate-like glass member into small pieces after the first chemical strengthening process, thereby obtaining a plurality of glass substrates, and a second chemical strengthening process for chemically strengthening the glass substrates by ion exchange after the cutting process.

### TECHNICAL FIELD

This invention relates to a method of manufacturing a glass substrate for use as a cover glass for a mobile electronic device and further relates to a glass substrate for use as a cover glass for a mobile electronic device and to a mobile electronic device.

### BACKGROUND ART

Mobile electronic devices, including mobile terminal devices such as a mobile telephone and a PDA (personal digital assistant), of the type having a display panel are widely known. As this type of display panel used in the mobile electronic device, there is known a thin display panel such as a liquid crystal display panel or an organic EL (electroluminescent) (also called an organic light-emitting diode) display panel.

In general, a display screen of the display panel is protected by a cover glass. As the cover glass for the mobile electronic device, a glass substrate made of a chemically strengthened glass is used. Chemical strengthening is a treatment for strengthening a glass by forming a compressive stress layer at a surface layer portion of the glass by ion exchange. The chemically strengthened glass represents a glass which is chemically strengthened. The glass substrate for use as the cover glass is manufactured, for example, in the following sequence.

First, a plate-like glass member is cut into small pieces of a predetermined shape, thereby obtaining glass substrates. Then, the glass substrates are immersed in a molten salt so as to be chemically strengthened. Then, if necessary, functional films such as an antireflection film are formed on main surfaces of the chemically strengthened glass substrates. The glass substrates thus obtained are each used as a cover glass or the like (see, e.g. JP-A-2007-99557 (Patent Document 1)).

Throughout the specification and claims, the term “cut” represents dividing an object into small pieces by any means such as, for example, machining or etching.

In the manufacturing sequence described above, cutting of the plate-like glass member can be carried out by machining such as scribe cutting using a diamond cutter wheel. Other than by machining, it is also proposed to carry out cutting of the plate-like glass member by etching. Specifically, it is proposed to carry out cutting of the plate-like glass member by wet etching (see, JP-A-2009-167086 (Patent Document 2)) or by dry etching (see, JP-A-S63-248730 (Patent Document 3)). Further, it is also proposed to, after forming various functional films on a plate-like glass member, cut the plate-like glass member along with the functional films by etching.

### SUMMARY OF THE INVENTION

However, in the conventional glass substrate manufacturing methods, a large-size plate-like glass member, on the assumption of multiple piece cutting (method of cutting out a plurality of glass substrates from a single plate glass), is cut into small pieces as glass substrates and these glass substrates are chemically strengthened by ion exchange, and therefore, the following problem arises. That is, it is generally said that since glass chemical strengthening does not cause deformation, high dimensional accuracy is obtained, but actually, the size of a glass substrate changes before and after the ion exchange. This change in size may become an issue when the glass substrate is attached to a portion where particularly high dimensional accuracy is required.

As a measure for this, it is possible to employ, for example, a sequence such that, in reverse to the above-mentioned manufacturing sequence, a large-size plate-like glass member is first chemically strengthened and then is cut into small pieces as glass substrates. However, if such a manufacturing sequence is employed, there arises another problem different from that caused by the above-mentioned manufacturing sequence. Specifically, when the plate-like glass member is cut into small pieces as glass substrates by etching or machining, end faces of the respective glass substrates are newly exposed. As a consequence, the end faces of the glass substrates are in a state of not being chemically strengthened. Therefore, there is a possibility that chemical strengthening is insufficient in terms of the entirety of each glass substrate.

A main object of this invention is to provide a technique that can simultaneously achieve, when manufacturing a plurality of glass substrates from a single plate-like glass member, (1) obtaining the glass substrates whose main surfaces and end faces are all chemically strengthened, (2) reducing the dimensional error of the glass substrates, and (3) maintaining the strength of the glass substrates to be excellent without sacrificing the productivity of the glass substrates.

According to a first aspect of the present invention, there is provided a method of manufacturing a glass substrate for use as a cover glass for a mobile electronic device, comprising a first chemical strengthening process for chemically strengthening a plate-like glass member by ion exchange, a cutting process for cutting the plate-like glass member into small pieces after the first chemical strengthening process, thereby obtaining a plurality of glass substrates, and a second chemical strengthening process for chemically strengthening the glass substrates by ion exchange after the cutting process.

According to a second aspect of the present invention, there is provided a method of manufacturing a glass substrate for use as a cover glass for a mobile electronic device, comprising a cutting process for cutting a plate-like glass member, chemically strengthened by ion exchange in a first chemical strengthening process, into small pieces to obtain a plurality of glass substrates, and a second chemical strengthening process for chemically strengthening the glass substrates by ion exchange after the cutting process.

According to a third aspect of the present invention, there is provided the method according to the first or the second aspect, wherein the ion exchange in the first chemical strengthening process and the ion exchange in the second chemical strengthening process are carried out under different conditions.

According to a fourth aspect of the present invention, there is provided the method according to the third aspect, wherein, in the first chemical strengthening process, the plate-like glass member is ion-exchanged by immersion in a molten salt, and wherein, in the second chemical strengthening process, the glass substrates are ion-exchanged by immersion in a molten salt for an immersion time shorter than that in the first chemical strengthening process.

According to a fifth aspect of the present invention, there is provided the method according to the first or the second aspect, wherein the ion exchange in the first chemical strengthening process and the ion exchange in the second chemical strengthening process are carried out under the same condition.

According to a sixth aspect of the present invention, there is provided the method according to any one of the first to the fifth aspects, wherein the plate-like glass member is cut by etching in the cutting process.

According to a seventh aspect of the present invention, there is provided the method according to any one of the first to the sixth aspects, wherein the content of an ion diffusion inhibitor in a strengthening salt used in the second chemical strengthening process is lower than the content of the ion diffusion inhibitor in a strengthening salt used in the first chemical strengthening process.

According to an eighth aspect of the present invention, there is provided a glass substrate for use as a cover glass for a mobile electronic device, the glass substrate having a plate shape as a whole and comprising a main surface perpendicular to a thickness direction of the glass substrate and an end face other than the main surface, wherein the main surface and the end face are respectively formed with compressive stress layers by chemical strengthening and a thickness of the compressive stress layer formed on the main surface is greater than that of the compressive stress layer formed on the end face.

According to a ninth aspect of the present invention, there is provided a mobile electronic device comprising a display panel having a display screen for displaying an image and a cover glass protecting the display screen, wherein the cover glass comprises the glass substrate according to the eighth aspect.

According to this invention, when manufacturing a plurality of glass substrates from a single plate-like glass member, it is possible to simultaneously achieve (1) obtaining the glass substrates whose main surfaces and end faces are all chemically strengthened, (2) reducing the dimensional error of the glass substrates, and (3) maintaining the strength of the glass substrates to be excellent without sacrificing the productivity of the glass substrates.

### BRIEF DESCRIPTION OF THE DRAWINGS

FIGS. 1A and 1B are diagrams showing an example of the structure of a mobile terminal device to which this invention is applied;

FIGS. 2A to 2D are diagrams respectively showing specific examples of plan-view shapes when a glass substrate according to this invention is used as a cover glass;

FIG. 3 is a process flow diagram for explaining a glass substrate manufacturing method according to an embodiment of this invention;

FIG. 4 is a diagram for explaining the principle of chemical strengthening by ion exchange;

FIG. 5 is a cross-sectional view showing a main portion of a glass substrate at an intermediate stage of the manufacturing processes;

FIG. 6 is a cross-sectional view showing a main portion of a glass substrate obtained by the glass substrate manufacturing method according to the embodiment of this invention; and

FIGS. 7A to 7C are cross-sectional views exemplarily showing internal stress profiles of chemically strengthened glass substrates, respectively.

### DESCRIPTION OF THE INVENTION

Hereinbelow, an embodiment of this invention will be described in detail with reference to the drawings.

In the embodiment of this invention, a description will be given in the following order.

1. Example of Structure of Mobile Terminal Device

2. Examples of Glass Substrate Shapes

3. Glass Substrate Manufacturing Method

4. Section of Glass Substrate Main Portion

5. Effect according to Embodiment

6. Modifications

### 1. Example of Structure of Mobile Terminal Device

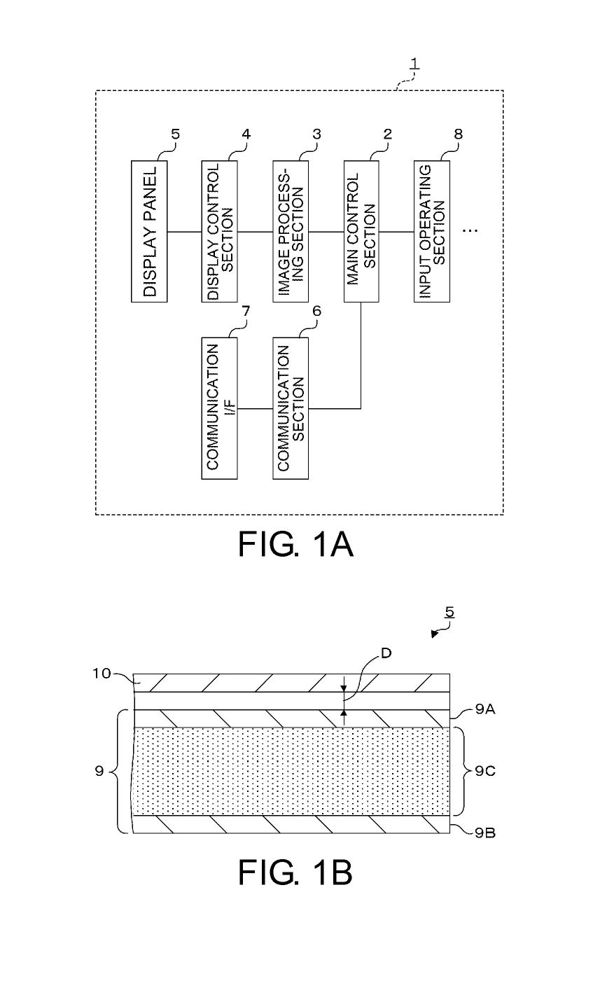

FIGS. 1A and 1B are diagrams showing an example of the structure of a mobile terminal device as a mobile electronic device to which this invention is applied. More specifically, FIG. 1A is a block diagram schematically showing part of functions of the mobile terminal device and FIG. 1B is an enlarged cross-sectional view of a portion of a display panel used in the mobile terminal device.

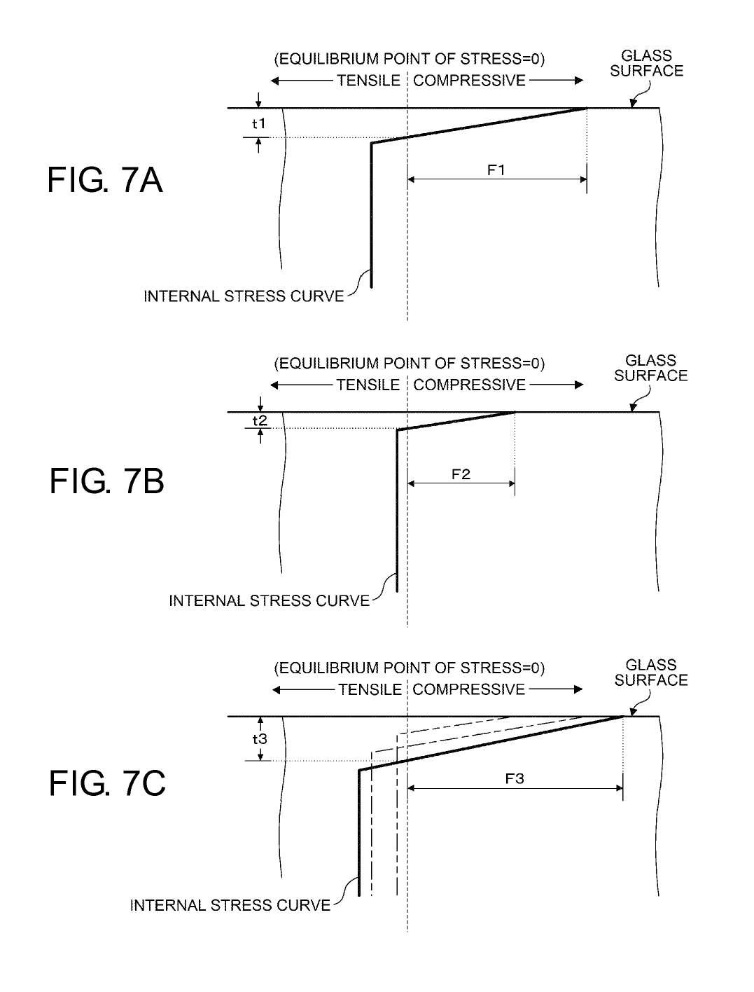

First, the structure of a mobile terminal device 1 will be described with reference to FIG. 1A. As seen from the figure, the mobile terminal device 1 comprises a main control section 2, an image processing section 3, a display control section 4, a display panel 5, a communication section 6, a communication interface (shown as “I/F” in the FIG. 7, an input operating section 8, and so on. Herein, as one example, a mobile terminal device such as a mobile telephone or a PDA is assumed as a mobile electronic device.

The main control section 2 generally controls various processes and operations in the mobile terminal device 1. The image processing section 3 carries out image processing on image data which are handled by the mobile terminal device 1. The display control section 4 displays the image data processed by the image processing section 3 on a display screen of the display panel 5 and controls switching of the display. The display panel 5 visualizes and displays the image data under the control of the display control section 4.

The communication section 6 transmits and receives various electronic data (including image data) between itself and a non-illustrated external communication device. The communication section 6 has, for example, a wireless communication function and a network communication function using radio waves and a wireless communication function using infrared rays. The communication interface 7 is an interface for realizing the communication functions described above. The input operating section 8 is operated by a user of the mobile terminal device 1 for inputting data. The input operating section 8 comprises, for example, buttons, keys, and switches.

The mobile terminal device 1 may also have various functions (e.g. camera function, game function, music reproducing function, animation reproducing function, and data storage function) other than the functional components described above, while, a description of those other components is omitted herein. This invention is applicable to a terminal device if it has at least a display panel, and is particularly suitably applied to a terminal device, as the above-mentioned mobile terminal device 1, which requires a reduction in size and further a reduction in thickness and weight.

Referring now to FIG. 1B, the structure of the display panel 5 will be described. The illustrated display panel 5 is a liquid crystal display panel and comprises a panel body 9 and a cover glass 10. The panel body 9 has a structure in which a liquid crystal layer 9C is filled between a pair of panel substrates 9A and 9B. The panel substrate 9A is a color filter substrate having a non-illustrated color filter layer, while the panel substrate 9B is a driving substrate having non-illustrated pixel electrodes, wiring patterns, and so on.

The cover glass 10 serves to protect the display screen of the display panel 5. The display screen of the display panel 5 is a surface on which an image is displayed for the user of the mobile terminal device 1. In the case of the illustrated display panel 5, an upper surface of the panel substrate 9A corresponds to a “display screen”. An appropriate gap D is formed between the panel substrate 9A and the cover glass 10.

A display panel of a mobile terminal device is not limited to the above-mentioned liquid crystal display panel and may be, for example, an organic EL display panel or a display panel of any other type. That is, when a glass substrate according to this invention is used as a cover glass, the form (kind, type, etc.) of a display panel may be any form as long as it has a display screen as a protection object. Further, electrodes, wiring patterns, and so on may be formed on a main surface of a cover glass using transparent conductive materials, thereby forming a touch panel.

### 2. Examples of Glass Substrate Shapes

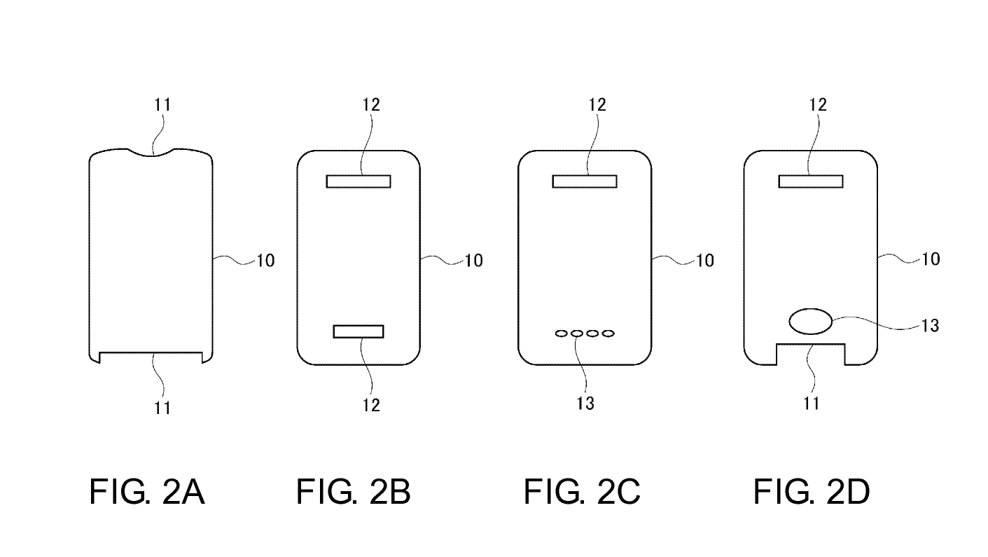

FIGS. 2A to 2D are diagrams respectively showing specific examples of plan-view shapes when a glass substrate according to this invention is used as a cover glass for a mobile terminal device.

The cover glass 10 has an external shape having rounded corners and having a size large enough to cover the display screen of the display panel 5. Further, the cover glass 10 has cutouts 11 and/or holes 12, 13 which are formed according to the operation key layout of the input operating section 8 and so on. Specifically, there are various shapes depending on the type of mobile terminal device and so on, such as the shape having cutouts 11 as shown in FIG. 2A, the shape having rectangular holes 12 as shown in FIG. 2B, the shape having a rectangular hole 12 and round holes 13 as shown in FIG. 2C, and the shape having a cutout 11, a rectangular hole 12, and a round hole 13 as shown in FIG. 2D.

The shape of the cover glass 10 described above is complicated as compared with a simple rectangular shape which can be formed only by linear processing. Accordingly, it is preferable to employ etching rather than machining such as scribe cutting. The technical basis for this is as follows.

(1) If etching is employed, it is possible to flexibly deal with a complicated external shape which cannot be dealt with by machining.

(2) If etching is employed, it is possible to simultaneously carry out cutting-out of the external shape and formation of the cutouts 11 or the like. On the other hand, in the case of machining, it is necessary that, after cutting out a rectangular shape with a size greater than the external size of a glass substrate to be finally obtained, the cut-out rectangular glass substrate be subjected to external shaping in one process or two processes.

Further, if perforation is required at other than the outer periphery, a perforation process using a dedicated tool is separately required apart from the outer periphery processing.

(3) If machining is employed, microcracks occur on an end face formed in the processing, while, if etching is employed, no microcracks occur due to the etching on an end face formed in the processing so that the end face has very high smoothness.

### 3. Glass Substrate Manufacturing Method

Next, a glass substrate manufacturing method according to the embodiment of this invention will be described.

First, there is prepared a plate-like glass member as a base member for small-piece glass substrates to be finally obtained. The plate-like glass member is in the form of a thin flat glass plate. The plate-like glass member has a square or rectangular external shape on the assumption of multiple piece cutting. As one example, the plate-like glass member has a rectangular shape with a long side of 80 mm, a short side of 45 mm, and a thickness of 0.5 mm.

The plate-like glass member contains one or more kinds of alkali metal components in addition to SiO₂ which is an essential component forming a glass skeleton. As the alkali metal components, use can be made of, for example, Na₂O and Li₂O. Na₂O is a component that provides sodium ions which are mainly replaced by potassium ions in ion exchange. Li₂O is a component that provides lithium ions which are mainly replaced by sodium ions in ion exchange. Li₂O is higher in ion-exchange rate than Na₂O and thus is used for forming a thick compressive stress layer in a short time.

As a specific example of a glass material forming the plate-like glass member, there can be cited an aluminosilicate glass, a sodalime glass, a borosilicate glass, or the like. In terms of the productivity, mechanical strength, chemical durability, and so on of the plate-like glass member, the aluminosilicate glass preferably contains 62 wt % to 75 wt % SiO₂, 5 wt % to 15 wt % Al₂O₃, 0 to 8 wt % Li₂O, 4 wt % to 16 wt % Na₂O, 0 to 12 wt % ZrO₂, and 0 to 8 wt % MgO. Al₂O₃ is a component which is contained for improving the ion-exchange performance on a glass surface. ZrO₂ and MgO are each a component which is contained for enhancing the mechanical strength.

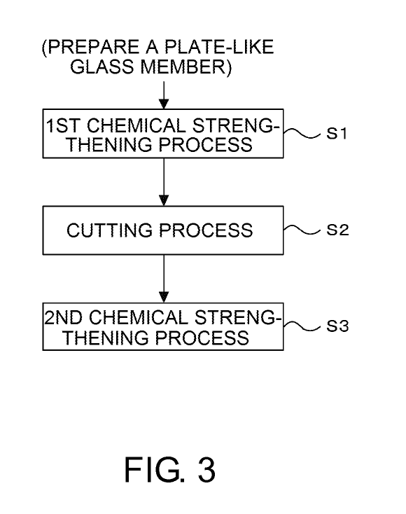

After preparing the above-mentioned plate-like glass member, a first chemical strengthening process (S1), a cutting process (S2), and a second chemical strengthening process (S3) are carried out in this order as shown in FIG. 3. Hereinbelow, the respective processes (S1 to S3) will be described in order. In FIG. 3, there are shown only those processes that are necessary for explaining the contents of this invention.

First Chemical Strengthening Process: S1

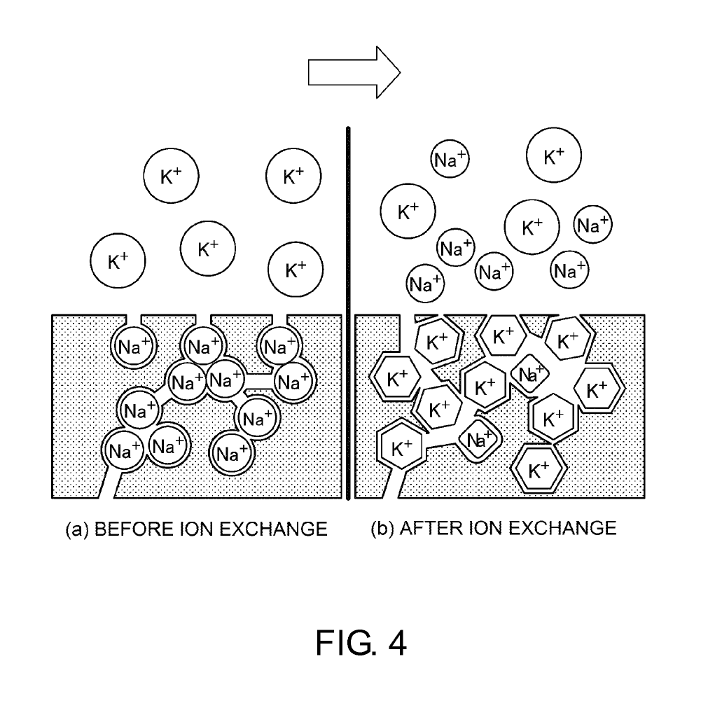

In the first chemical strengthening process S1, the above-mentioned plate-like glass member is chemically strengthened by ion exchange. Specifically, the plate-like glass member, which is not chemically strengthened, is ion-exchanged by immersion in a molten salt containing one or more kinds of alkali metal components. More specifically, the plate-like glass member is immersed in a mixed-salt treatment solution of potassium nitrate (KNO₃) and sodium nitrate (NaNO₃), which is maintained at a predetermined temperature (e.g. 350° C. to 400° C.), for a predetermined time (e.g. 4 hours), thereby carrying out ion exchange based on substitution of metal ions having different ionic radii. In this ion exchange, metal ions of a metal oxide originally contained in the plate-like glass member are replaced by metal ions having a greater ionic radius. Thus, for example, as shown in (a) and (b) of FIG. 4, sodium ions (Na⁺) contained in the plate-like glass member are replaced by potassium ions (K⁺) having a greater ionic radius. As a result, a layer having compressive stress, i.e. a compressive stress layer, is formed at a surface layer portion of the plate-like glass member after the ion exchange. Simultaneously with the formation of the compressive stress layer, a layer having tensile stress, i.e. a tensile stress layer, is formed at a deep layer portion (inner layer portion) of the plate-like glass member in order to balance the internal stress. That is, in the chemical strengthening process by the ion exchange, the compressive stress layer is formed at the surface layer portion of the plate-like glass member, while the tensile stress layer is formed at the deep layer portion other than the surface layer portion.

Cutting Process: S2

In the cutting process S2, the plate-like glass member chemically strengthened in the first chemical strengthening process S1 is cut into small pieces, thereby obtaining a plurality of glass substrates. This cutting process S2 may be carried out by machining such as scribe cutting, or etching. However, if the plate-like glass member is cut by machining, microcracks occur on a cut surface obtained by scribe cutting or the like, while, if the plate-like glass member is cut by etching, a cut or etched surface becomes very smooth with no microcracks or the like. Therefore, it is preferable to employ etching in the cutting process S2. Particularly when used as a cover glass, it is preferable to employ etching rather than machining in terms of the technical basis described before.

Herein, a description will be given of the processing contents when the plate-like glass member is cut by etching. First, a resist film as an etching resistant film is formed on at least one of main surfaces of the plate-like glass member. Then, using a photomask having a pattern corresponding to the external shape of glass substrates to be finally obtained, the resist film is exposed. Then, after developing the exposed resist film to form a resist pattern, this resist pattern is cured by heat treatment. Then, using the cured resist pattern as a mask, the plate-like glass member is etched. After the completion of the etching, the resist pattern is removed. The etching of the plate-like glass member may be wet etching or dry etching. A resist material forming the resist film is not particularly limited as long as it has resistance to an etchant used in the etching. Generally, in the case of a glass, etching proceeds by wet etching using an aqueous solution containing hydrofluoric acid or by dry etching using a fluorine-based gas. Accordingly, as the resist material, it is considered to use, for example, a material excellent in hydrofluoric acid resistance.

As the etchant for etching the plate-like glass member, use can be made of, for example, a mixed acid containing hydrofluoric acid and another acid. As the acid mixed with the hydrofluoric acid, use can be made of, for example, at least one of sulfuric acid, nitric acid, hydrochloric acid, and hydrofluosilic acid. By etching the plate-like glass member using such a mixed acid aqueous solution as the etchant, a plurality of glass substrates are obtained from the single (large-size) plate-like glass member in a state of being separated into small pieces. In this case, end faces of the individual glass substrates each have a surface roughness (Ra) of 10 nm or less, i.e. a high smoothness on the order of nanometers.

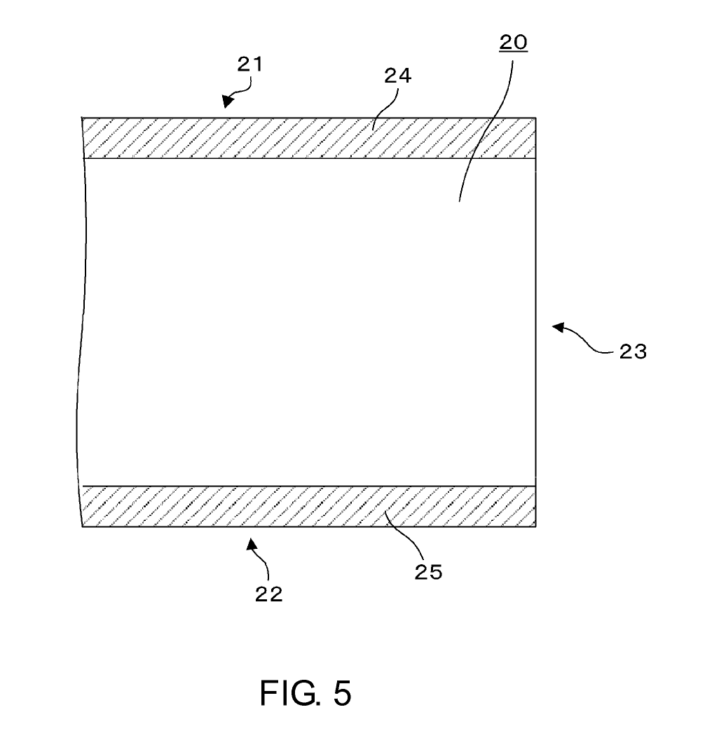

Herein, the definition of “surface” of the glass substrate and the state of the glass substrate after the cutting process will be described in order with reference to FIG. 5.

First, the definition of “surface” of a glass substrate 20 will be described. The glass substrate 20 has two main surfaces 21 and 22 and end faces 23. The main surfaces 21 and 22 of the glass substrate 20 are planes which are perpendicular to a thickness direction of the glass substrate 20. These main surfaces 21 and 22 are present in the glass substrate 20 in a front and back positional relationship. The main surfaces 21 and 22 of the glass substrate 20 are obtained from the above-mentioned plate-like glass member and thus correspond to portions of two large main surfaces (planes) of the plate-like glass member, respectively. On the other hand, the end faces 23 of the glass substrate 20 represent all surfaces of the glass substrate 20 other than the main surfaces 21 and 22. Accordingly, the end faces 23 of the glass substrate 20 include not only end faces along the external shape of the glass substrate 20, but also end faces along the shapes of holes. Therefore, for example, end faces of the cover glasses 10 shown in FIGS. 2A to 2D include not only end faces along the external shapes (including the cutouts 11) of the cover glasses 10, but also end faces along the shapes of the rectangular holes 12 and the round holes 13.

Next, the state of the glass substrate 20 after the cutting process will be described.

At a stage after the above-mentioned cutting process S2 and before the later-described second chemical strengthening process S3, the main surfaces 21 and 22 of the glass substrate 20 are in a state where compressive stress layers 24 and 25 are respectively formed. The compressive stress layers 24 and 25 are formed by the above-mentioned first chemical strengthening process S1. On the other hand, the end faces 23 of the glass substrate 20 are in a state where no compressive stress layer is formed. The reason is that the end faces 23 of the glass substrate 20 are exposed to the outside as newly formed surfaces due to etching or machining in the cutting process S2.

Second Chemical Strengthening Process: S3

In the second chemical strengthening process S3, the glass substrates cut into small pieces in the above-mentioned cutting process S2 are chemically strengthened by ion exchange. Specifically, for example, the glass substrates cut into small pieces are set side by side on a tray and then are ion-exchanged by immersion along with the tray in a molten salt containing alkali metal components. By this ion exchange, a compressive stress layer is formed at surface layer portions of the main surfaces and end faces of the glass substrates based on the same principle as in the above-mentioned first chemical strengthening process S1. However, the compressive stress layer is already formed on the main surfaces of the glass substrates by the above-mentioned first chemical strengthening process S1. As a consequence, when the second chemical strengthening process S3 is carried out, the ion exchange proceeds to increase the thickness of the compressive stress layer formed on the main surfaces of the glass substrates. The thickness of the compressive stress layer represents the thickness of a glass surface layer portion in which the ion exchange is actually carried out by the immersion in the molten salt. On the other hand, by carrying out the second chemical strengthening process S3, a compressive stress layer is formed at surface layer portions of the end faces of the glass substrates. As a result, the compressive stress layer is formed over the entire surface (main surfaces and end faces) of each glass substrate. The compressive stress layer formed on the main surfaces of each glass substrate becomes thicker than the compressive stress layer formed on the end faces of the glass substrate.

It is preferable that the ion exchange of the glass substrates in the second chemical strengthening process S3 be carried out under the conditions different from those in the first chemical strengthening process S1 with respect to, for example, treatment conditions such as the composition of the treatment solution (the ratio of mixed salts in the molten salt), the temperature of the treatment solution, and the immersion time. The reason is that although the first chemical strengthening process S1 and the second chemical strengthening process S3 are the same ion-exchange-based chemical strengthening, the thicknesses of the compressive stress layers to be formed by the ion exchange are different from each other. This also means that the mechanical strength required for the main surfaces of the glass substrate and the mechanical strength required for the end faces of the glass substrate differ from each other. Particularly, in recent mobile electronic devices, the products which are operated by directly contacting a cover glass using a touch pen or the like have increased so that high mechanical strength (damage resistance, breaking strength, rigidity, etc.) of the main surfaces is required.

As a specific example in that case, it is preferable that, in the second chemical strengthening process S3, the glass substrates be ion-exchanged by immersion in the molten salt for an immersion time shorter than that in the first chemical strengthening process S1. Changing the immersion time is advantageous in the following point as compared with changing the other treatment condition such as the composition or temperature of the treatment solution. That is, it is advantageous in that when the first chemical strengthening process S1 and the second chemical strengthening process S3 are carried out using the same treatment bath, it does not take time to change the setup and the process management does not become complicated with the change in treatment condition.

### 4. Section of Glass Substrate Main Portion

Next, the structure of the glass substrate according to the embodiment of this invention will be described.

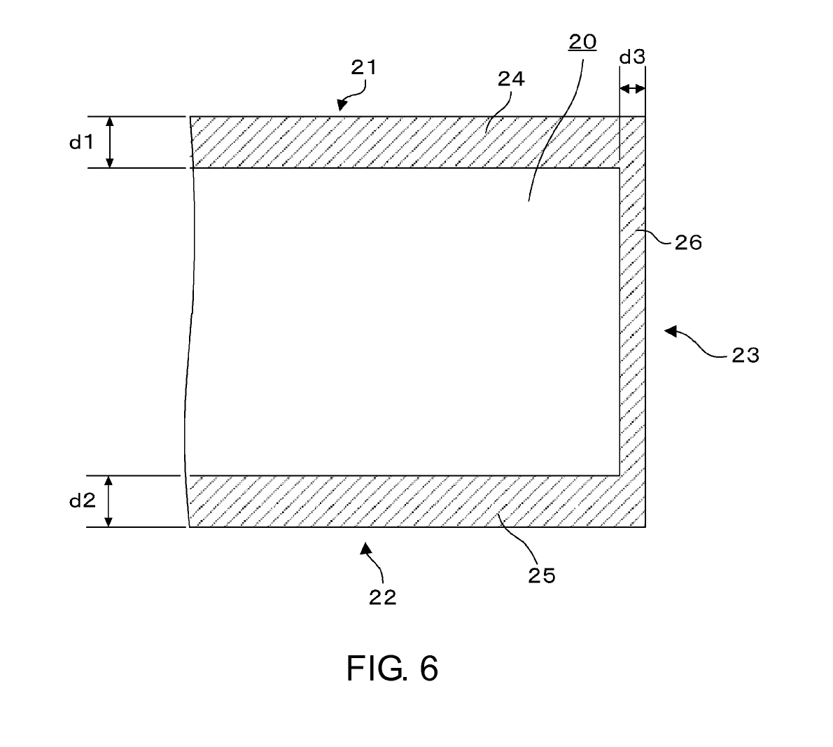

FIG. 6 is a cross-sectional view showing a main portion of a glass substrate 20 obtained by the above-mentioned manufacturing method. As illustrated, main surfaces 21 and 22 of the glass substrate 20 are respectively formed with compressive stress layers 24 and 25 by chemical strengthening and end faces 23 of the glass substrate 20 are also respectively formed with compressive stress layers 26 by chemical strengthening. That is, the compressive stress layer is formed over the entire surface of the glass substrate 20.

Herein, it is assumed that the thickness of the compressive stress layer 24 formed on the main surface 21 of the glass substrate 20 is given by d1, the thickness of the compressive stress layer 25 formed on the other main surface 22 of the glass substrate 20 is given by d2, and the thickness of the compressive stress layer 26 formed on the end face 23 of the glass substrate 20 is given by d3. In this case, the relationship of the thicknesses of the compressive stress layers 24, 25, and 26 becomes d1=d2 and d1>d3. The reason is that while the main surfaces 21 and 22 of the glass substrate 20 are formed with the compressive stress layers 24 and 25 by the first chemical strengthening process S1 and the second chemical strengthening process S3, the end face 23 of the glass substrate 20 is formed with the compressive stress layer 26 only by the second chemical strengthening process S3.

Incidentally, if the plate-like glass member is cut into small pieces by machining in the cutting process S2, an end face of a glass substrate becomes a surface which is substantially perpendicular to a main surface thereof, while, if it is cut into small pieces by etching, an end face of a glass substrate becomes a surface which is inclined to a main surface thereof. This is caused by the fact that etching of a glass proceeds isotropically. At any rate, the thickness of a compressive stress layer formed on the end face of the glass substrate becomes smaller than that of a compressive stress layer formed on the main surface thereof.

Accordingly, the stress profile of the compressive stress layer 24, 25 formed on the main surface 21, 22 of the glass substrate 20 and the stress profile of the compressive stress layer 26 formed on the end face 23 of the glass substrate 20 differ from each other. Hereinbelow, this will be described in further detail.

When a compressive stress layer is formed at a surface layer portion of a glass substrate by chemical strengthening by ion exchange, a tensile stress layer is formed at a deep layer portion of the glass substrate in order to achieve stress balance. Therefore, the stress profile of stress generated inside the glass substrate (hereinafter referred to as “internal stress”) is represented by stress curves of compressive stress and tensile stress forming the internal stress. The stress profile of the compressive stress changes depending on a thickness t (μm) of the compressive stress layer and a maximum value F(MPa) of the compressive stress (maximum compressive stress value F(MPa)) generated there.

FIGS. 7A to 7C are cross-sectional views exemplarily showing internal stress profiles of chemically strengthened glass substrates, respectively. In FIGS. 7A to 7C, a point of stress=0 (equilibrium point) where compressive stress and tensile stress are in an equilibrium state is indicated by a vertical broken line. With respect to this broken line as a boundary, a stress curve on the right side in the figure represents a profile of the compressive stress, while a stress curve on the left side in the figure represents a profile of the tensile stress.

FIG. 7A shows the profile of stress which, when a non-strengthened glass substrate is ion-exchanged under the same conditions as in the above-mentioned first chemical strengthening process S1, is generated inside the glass substrate. FIG. 7B shows the profile of stress which, when a non-strengthened glass substrate is ion-exchanged under the same conditions as in the above-mentioned second chemical strengthening process S3, is generated inside the glass substrate. FIG. 7C shows the profile of stress which is generated inside a glass substrate when the glass substrate is manufactured by the manufacturing method according to the embodiment of this invention.

When a compressive stress layer is formed at a surface layer portion of the glass substrate by the first chemical strengthening process S1, the thickness of the compressive stress layer becomes t1 and the maximum compressive stress value becomes F1 as shown in FIG. 7A. On the other hand, when a compressive stress layer is formed at a surface layer portion of the glass substrate by the second chemical strengthening process S3, the thickness of the compressive stress layer becomes t2 and the maximum compressive stress value becomes F2 as shown in FIG. 7B. Further, when a compressive stress layer is formed at a surface layer portion of the glass substrate by the first chemical strengthening process S1 and the second chemical strengthening process S3, the thickness of the compressive stress layer becomes t3 and the maximum compressive stress value becomes F3 as shown in FIG. 7C.

Therefore, when a glass substrate is manufactured by the above-mentioned manufacturing method, stress profiles of compressive stress layers formed on respective surfaces of this glass substrate become as follows. Specifically, the stress profile of the compressive stress layer formed on the end face of the glass substrate becomes the profile shown in FIG. 7B, while the stress profile of the compressive stress layer formed on the main surface of the glass substrate becomes the profile shown in FIG. 7C.

In FIG. 7C, as a reference, the stress profile shown in FIG. 7A is shown by a one-dot chain line and the stress profile shown in FIG. 7B is shown by a two-dot chain line. As seen from this, the stress profile shown in FIG. 7C is a combination of the stress profile of FIG. 7A and the stress profile of FIG. 7B.

Further, as seen from a comparison of FIGS. 7A to 7C, the relationship of the maximum compressive stress values and the relationship of the thicknesses of the compressive stress layers are as follows.

F3>F1>F2

t3>t1>t2

Assuming that the product (F×t) of the thickness t of the compressive stress layer and the maximum compressive stress value F is defined as X(MPa·μm) and that, based on this definition, the product of t1 and F1 is given by X1 and the product of t2 and F2 is given by X2, these values establish a relationship of X1>X2.

As a specific example, assuming that the thickness of the glass substrate is in a range of 0.5 to 1.2 mm, numerical value ranges of t1, t2, F1, and F2 are, for example, as follows provided that those numerical value ranges satisfy the above-mentioned relationships. Specifically, the numerical value range of t1 is 20 to 100 μm, the numerical value range of t2 is 10 to 80 μm, the numerical value range of F1 is 250 to 1000 MPa, and the numerical value range of F2 is 100 to 800 MPa.

From the above, the properties in terms of strength of the glass substrate 20 obtained by the above-mentioned manufacturing method are such that the main surfaces 21 and 22 are chemically strengthened more strongly and deeply than the end faces 23.

### 5. Effect According to Embodiment

According to the glass substrate and its manufacturing method of the embodiment of this invention, when manufacturing a plurality of glass substrates from a single large-size plate-like glass member, it is possible to simultaneously achieve (1) obtaining the glass substrates whose main surfaces and end faces are all chemically strengthened, (2) reducing the dimensional error of the glass substrates, and (3) maintaining the strength of the glass substrates to be excellent without sacrificing the productivity of the glass substrates. Hereinbelow, the technical basis will be described.

Concerning Item (1)

First, by chemically strengthening a plate-like glass member in the first chemical strengthening process S1 before the cutting process S2, at least main surfaces of glass substrates to be finally obtained are chemically strengthened. Thereafter, by cutting the plate-like glass member into small pieces as glass substrates in the cutting process S2 and then chemically strengthening the glass substrates in the second chemical strengthening process S3, end faces of the glass substrates to be finally obtained are chemically strengthened. As a result, the glass substrates whose main surfaces and end faces are all chemically strengthened are obtained.

Concerning Item (2)

When a plate-like glass member is chemically strengthened in the first chemical strengthening process S1 before the cutting process S2, the size of the plate-like glass member slightly changes before and after the ion exchange. However, since the plate-like glass member is cut into a plurality of glass substrates thereafter, the dimensional change generated before that does not affect the size of the glass substrates. Therefore, the size of each glass substrate is as designed. When the glass substrates divided into small pieces are chemically strengthened in the second chemical strengthening process S3, the treatment time of this chemical strengthening can be shortened as compared with the treatment time of the first chemical strengthening. Accordingly, as compared with the dimensional change generated in the first chemical strengthening, a dimensional change generated in the second chemical strengthening is very small. Therefore, as compared with the case where a non-strengthened plate-like glass member is cut into small-piece glass substrates and then these glass substrates are chemically strengthened, it is possible to reduce the dimensional error of the glass substrates.

Concerning Item (3)

Only for the purpose of increasing the strength of a glass substrate, it is sufficient to form a thick compressive stress layer at a surface layer portion of the glass substrate by one-time ion exchange. However, in order to form the thick compressive stress layer, it is necessary to carry out the ion exchange (immersion in a molten salt, etc.) for a correspondingly long time.

Herein, for the sake of explanation, it is assumed that the ion-exchange treatment time necessary for forming a compressive stress layer having a predetermined thickness is given by “Tref”. In this case, when forming the compressive stress layer having the predetermined thickness at a surface layer portion of a glass substrate only by one-time ion exchange, the treatment time is set to Tref. On the other hand, in the glass substrate manufacturing method according to this invention, provided that Tref=T1+T2, a plate-like glass member is chemically strengthened for the treatment time T1 in the first chemical strengthening process S1 before the cutting process S2 and then glass substrates are chemically strengthened for the treatment time T2 in the second chemical strengthening process S3 after the cutting process S2. As a consequence, the total treatment time for chemical strengthening is substantially unchanged. Thus, the productivity is not sacrificed.

On the other hand, the following merit is obtained in terms of strength of the glass substrate. Specifically, a compressive stress layer having a thickness equal to that which is obtained when chemical strengthening is carried out for the treatment time Tref is formed on main surfaces of the glass substrate to be finally obtained. On the other hand, a compressive stress layer having a thickness corresponding to the treatment time T2 is formed on end faces of the glass substrate to be finally obtained. As a result, the main surfaces of the glass substrate are chemically strengthened by the relatively thick compressive stress layer, while the end faces of the glass substrate are chemically strengthened by the relatively thin compressive stress layer.

Therefore, it is advantageous when the glass substrate is used, for example, as a cover glass for a mobile terminal device. The reason is as follows. Specifically, when the mobile terminal device is used or carried, an external force tends to be applied to the main surfaces of the glass substrate as compared with the end faces thereof and this tendency is significant particularly when the glass substrate is used as a touch panel. Accordingly, when strengthening the glass substrate, it is preferable to more firmly strengthen the main surfaces of the glass substrate. Thus, it is advantageous in terms of strength to form the relatively thick compressive stress layer on the main surfaces of the glass substrate.

After the mobile terminal device is completed using the glass substrate as the cover glass, there is almost no chance that an external force is applied to the end faces of the glass substrate. However, at an intermediate stage of the manufacturing processes up to the completion, there is a possibility that an external force is applied to the end faces of the glass substrate. Specifically, when the glass substrate is handled alone as a component, there is a possibility that an external force is applied to the end face of the glass substrate due to contact with another component or the like. Further, when the main surfaces of the glass substrate are chemically strengthened firmly, large tensile stress is generated correspondingly at a deep layer portion of the glass substrate. As a consequence, even if a relatively small external force is applied to the end face of the glass substrate, there is a possibility that a crack or the like occurs in the glass substrate starting therefrom to break the glass substrate. Thus, it is advantageous in terms of strength to chemically strengthen not only the main surfaces of the glass substrate, but also the end faces of the glass substrate.

Based on the technical basis described above, the above-mentioned items (1) to (3) are simultaneously achieved.

In this embodiment, the ion exchange in the first chemical strengthening process S1 and the ion exchange in the second chemical strengthening process S3 are carried out under different conditions. Accordingly, depending on the mechanical strength required for the main surfaces 21 and 22 of the glass substrate 20 and the mechanical strength required for the end faces 23 of the glass substrate 20, the thicknesses of the compressive stress layers that are formed on the respective glass surfaces can be adjusted.

Further, in the second chemical strengthening process S3, by immersing the glass substrate in a molten salt for an immersion time shorter than that in the first chemical strengthening process S1, i.e. under a condition of T1>T2, most of a dimensional change to be generated in the glass substrate due to chemical strengthening can be generated before the cutting process S2. Therefore, as compared with the case where a condition of T1<T2 is employed, it is possible to reduce the dimensional error of the glass substrate.

Further, in the cutting process S2, since the plate-like glass member is cut by etching, it is possible to flexibly and easily deal with even a complicated processing shape and to obtain high dimensional accuracy, an excellent processing surface state (e.g. surface roughness Ra of 10 nm or less), and so on.

In the glass substrate 20 according to the embodiment of this invention, the main surfaces 21 and 22 and the end faces 23 are respectively formed with the compressive stress layers 24, 25, and 26 by chemical strengthening and, further, the thickness of the compressive stress layer 24, 25 formed on the main surface 21, 22 is greater than the thickness of the compressive stress layer 26 formed on the end face 23. Therefore, particularly when the glass substrate 20 is used as a cover glass of a display panel of a terminal device such as a mobile telephone or a PDA, the cover glass, while it is very thin, can protect a display surface of the display panel with sufficient strength. Thus, it contributes to an improvement in the commodity properties of the terminal device.

### 6. Modifications

The technical scope of this invention is not limited to the above-mentioned embodiment and includes an aspect added with various changes or improvements in a range where a specific effect, which is obtained by the constituent features of this invention or a combination thereof, can be derived.

For example, in the above-mentioned embodiment, the ion exchange in the first chemical strengthening process S1 and the ion exchange in the second chemical strengthening process S3 are carried out under different conditions, but this invention is not limited thereto. That is, the ion exchange in the first chemical strengthening process S1 and the ion exchange in the second chemical strengthening process S3 may be carried out under the same conditions. In this case, the process management of the first chemical strengthening process S1 and the second chemical strengthening process S3 is facilitated.

### 6(1). Example of Using the Same Molten Salt Composition

Due to a component that is contained in the molten salt composition and inhibits ion exchange, for example, due to Li ions which are dissolved into a molten salt when a glass containing Li₂O in its composition is chemically strengthened using a mixed salt of KNO₃ and NaNO₃, ion exchange from Na ions to K ions is inhibited so that the desired stress is not obtained (Li ion concentration at which such inhibition significantly appears is about 10000 ppm).

This also applies to the case where a glass containing Na₂O in its composition is chemically strengthened using a simple salt of KNO₃. The Na concentration in a molten salt increases as it is repeatedly used so that ion exchange from Na ions to K ions is inhibited (Na ion concentration at which such inhibition significantly appears is about 5%).

Herein, the influence of Li or Na dissolved into the molten salt causes not only a problem on the strength, but also a problem that as the number of times of using the molten salt increases, the dimensional change due to chemical strengthening decreases as compared with that at the beginning of using the molten salt. As a result, variation occurs in the size of cover glasses.

As a method of solving these problems, it is possible to obtain the stable strength and dimensional accuracy by reducing the content of an ion diffusion inhibitor (Li or Na) in a molten salt for use in the second chemical strengthening process as compared with that in a molten salt for use in the first chemical strengthening process. Examples of the content of an ion diffusion inhibitor in a strengthening salt for an aluminosilicate glass (herein, containing at least 15 wt % Al₂O₃, 5 wt % Li₂O, and 10 wt % Na₂O) are as follows.

In the case of a mixed salt of KNO₃ and NaNO₃

Li ion content in a molten salt for use in the first chemical strengthening process:

2000 ppm or more and 20000 ppm or less

Li ion content in a molten salt for use in the second chemical strengthening process:

0 ppm or more and less than 2000 ppm

In the case of a simple salt of KNO₃

Na ion content in a molten salt for use in the first chemical strengthening process:

1% or more and 10% or less

Na ion content in a molten salt for use in the second chemical strengthening process:

0% or more and less than 1%

### 6(2). Example of Using Different Molten Salt Compositions

Using different molten salts in the first chemical strengthening process and the second chemical strengthening process, it is possible to form a firm compressive stress layer only at a surface layer portion of a glass substrate. For example, in the case of a glass containing Li₂O and Na₂O in its composition, chemical strengthening is carried out using a mixed salt of KNO₃ and NaNO₃ in the first chemical strengthening process to diffuse Na ions into a deep portion of the glass, thereby forming a sufficiently thick compressive stress layer.

Likewise, also in the case of a glass containing Na₂O in its composition (free of Li₂O), it is possible to carry out chemical strengthening using a mixed salt of KNO₃ and NaNO₃ in the first chemical strengthening process, thereby forming a sufficiently thick compressive stress layer. Since it is difficult to process a glass substrate when surface compressive stress is relatively high, the magnitude of the surface compressive stress is properly adjusted in the first chemical strengthening process.

Then, in the second chemical strengthening process, chemical strengthening is carried out by selecting the treatment conditions such as temperature and time and using, in the case of a mixed salt, a molten salt in which the content of KNO₃ is increased as compared with that in the first chemical strengthening process, or using a molten KNO₃ simple salt, so that it is possible to form a firm compressive stress layer only at a surface layer portion of the glass substrate.

### 6(3). Example of Adjusting Temperature and Time in Chemical Strengthening Process

Not only by selecting molten salts, but also by adjusting the temperature and time in the first chemical strengthening process and the second chemical strengthening process, it is possible to form a deep compressive stress layer with weak compressive stress in the first chemical strengthening process and, after the processing, it is possible to form a firm compressive stress layer at a surface layer portion in the second chemical strengthening process. Herein, the ion diffusion depth can be increased by a treatment at a higher temperature and for a longer time. Since stress relaxation proceeds simultaneously with ion diffusion, it is possible to form a compressive stress layer with a relatively small compressive stress value by adjusting the temperature to be relatively high.

Then, in the second chemical strengthening process, by carrying out chemical strengthening at a temperature lower than that in the first chemical strengthening process, it is possible to form a firm compressive stress layer only at a surface layer portion while preventing the stress relaxation. In the second chemical strengthening process, it is possible to form an intended stress profile more effectively by a combination with a method of adjusting the composition of a molten salt. A condition setting example for an aluminosilicate glass (herein, containing at least 15 wt % Al₂O₃, 5 wt % Li₂O, and 10 wt % Na₂O) is as follows.

First Ion-Exchange Process Condition

mixing ratio of KNO₃ to NaNO₃: 6:4

temperature: 380° C.

time: 0.5 hours

Second Ion-Exchange Process Condition

mixing ratio of KNO₃ to NaNO₃: 8:2

temperature: 360° C.

time: 1 hour

### 6(4). Example of Adding Other Processes

If necessary, other processes such as, for example, a functional film forming process and an inspection process may be provided in the above-mentioned sequence of processes as the glass substrate manufacturing method. The functional film forming process is a process of forming a functional film on at least one of two main surfaces of a glass substrate to be finally obtained. As the functional film formed by this process, there can be cited, for example, an antireflection film for preventing reflection on the glass surface, a conductive film for forming a touch panel or the like, an antifouling film for preventing dirt on the glass surface, a printed film for decorating the glass surface, or the like. The functional film forming process may be provided at a stage after the first chemical strengthening process S1 and before the cutting process S2, at a stage after the cutting process S2 and before the second chemical strengthening process S3, or at a stage after the second chemical strengthening process S3. By providing the functional film forming process before the cutting process S2, the functional film can be formed on a single large-size plate-like glass member by one-time film forming processing and, therefore, the production efficiency can be largely enhanced as compared with the case where the functional film is formed on individual glass substrates divided into small pieces. When the functional film forming process is provided before the second chemical strengthening process S3, it is preferable to provide masking on a portion where the functional film is formed, in order to prevent removal of or damage to the functional film which is otherwise caused by chemical strengthening.

The inspection process is a process of inspecting the external appearance of the glass substrate using, for example, a microscope and is provided as a final process in the manufacturing processes.

What is claimed is:

1. A method of manufacturing a glass substrate for use as a cover glass for a mobile electronic device, comprising:
a first chemical strengthening process for chemically strengthening a plate-like glass member by ion exchange;
a cutting process for cutting the plate-like glass member into small pieces after the first chemical strengthening process, thereby obtaining a plurality of glass substrates; and
a second chemical strengthening process for chemically strengthening the glass substrates by ion exchange after the cutting process.

2. The method according to claim 1, wherein the ion exchange in the first chemical strengthening process and the ion exchange in the second chemical strengthening process are carried out under different conditions.

3. The method according to claim 2,
wherein, in the first chemical strengthening process, the plate-like glass member is ion-exchanged by immersion in a molten salt, and
wherein, in the second chemical strengthening process, the glass substrates are ion-exchanged by immersion in a molten salt for an immersion time shorter than that in the first chemical strengthening process.

4. The method according to claim 1, wherein the ion exchange in the first chemical strengthening process and the ion exchange in the second chemical strengthening process are carried out under the same condition.

5. The method according to claim 1, wherein the plate-like glass member is cut by etching in the cutting process.

6. The method according to claim 2, wherein the plate-like glass member is cut by etching in the cutting process.

7. The method according to claim 1, wherein the content of an ion diffusion inhibitor in a strengthening salt used in the second chemical strengthening process is lower than the content of the ion diffusion inhibitor in a strengthening salt used in the first chemical strengthening process.

8. The method according to claim 2, wherein the content of an ion diffusion inhibitor in a strengthening salt used in the second chemical strengthening process is lower than the content of the ion diffusion inhibitor in a strengthening salt used in the first chemical strengthening process.

9. The method according to claim 3, wherein the content of an ion diffusion inhibitor in a strengthening salt used in the second chemical strengthening process is lower than the content of the ion diffusion inhibitor in a strengthening salt used in the first chemical strengthening process.

10. A method of manufacturing a glass substrate for use as a cover glass for a mobile electronic device, comprising:
a cutting process for cutting a plate-like glass member, chemically strengthened by ion exchange in a first chemical strengthening process, into small pieces to obtain a plurality of glass substrates; and
a second chemical strengthening process for chemically strengthening the glass substrates by ion exchange after the cutting process.

11. The method according to claim 10, wherein the ion exchange in the first chemical strengthening process and the ion exchange in the second chemical strengthening process are carried out under different conditions.

12. The method according to claim 11,
wherein, in the first chemical strengthening process, the plate-like glass member is ion-exchanged by immersion in a molten salt, and
wherein, in the second chemical strengthening process, the glass substrates are ion-exchanged by immersion in a molten salt for an immersion time shorter than that in the first chemical strengthening process.

13. The method according to claim 10, wherein the ion exchange in the first chemical strengthening process and the ion exchange in the second chemical strengthening process are carried out under the same condition.

14. The method according to claim 10, wherein the plate-like glass member is cut by etching in the cutting process.

15. The method according to claim 11, wherein the plate-like glass member is cut by etching in the cutting process.

16. The method according to claim 10, wherein the content of an ion diffusion inhibitor in a strengthening salt used in the second chemical strengthening process is lower than the content of the ion diffusion inhibitor in a strengthening salt used in the first chemical strengthening process.

17. The method according to claim 11, wherein the content of an ion diffusion inhibitor in a strengthening salt used in the second chemical strengthening process is lower than the content of the ion diffusion inhibitor in a strengthening salt used in the first chemical strengthening process.

18. The method according to claim 12, wherein the content of an ion diffusion inhibitor in a strengthening salt used in the second chemical strengthening process is lower than the content of the ion diffusion inhibitor in a strengthening salt used in the first chemical strengthening process.

19. A glass substrate for use as a cover glass for a mobile electronic device, the glass substrate having a plate shape as a whole and comprising a main surface perpendicular to a thickness direction of the glass substrate and an end face other than the main surface,
wherein the main surface and the end face are respectively formed with compressive stress layers by chemical strengthening and a thickness of the compressive stress layer formed on the main surface is greater than that of the compressive stress layer formed on the end face.

20. A mobile electronic device comprising a display panel having a display screen for displaying an image and a cover glass protecting the display screen,
wherein the cover glass comprises the glass substrate according to claim 19.
